(19) United States
(12) Patent Application Publication
(10) Pub. No.: US 2005/0053287 A1
(43) Pub. Date: Mar. 10, 2005

(54) Image processing system, image formation apparatus, image formation method, and program

(75) Inventors: Ikken So, Kanagawa (JP); Masanori Sekino, Kanagawa (JP); Taro Yokose, Kanagawa (JP); Yutaka Koshi, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/722,439

(22) Filed: Nov. 28, 2003

(30) Foreign Application Priority Data
Dec. 3, 2002 (JP) P. 2002-350769

(51) Int. Cl. G06K 9/36

(52) U.S. Cl. 382/232

(57) ABSTRACT

Filtering for enhancing the reversible compression rate is performed for image data as preprocessing of compression processing. For image processing after the filtering, repeating of compression and decompression according to the reversible compression technique corresponding to the filtering is allowed. As the filtering and reversible compression processing are performed, a sufficient compression ratio is provided and accumulation of image quality degradation by repeating compression and decompression is prevented.

### BACKGROUND OF THE INVENTION

1. Field of the Invention

This invention relates to an image processing system having coding section of image data. For example, it relates to an image processing system for repeating coding processing and decompression processing of image data several times in an image processing sequence.

2. Description of the Related Art

An image processing such as print processing involves a plurality of processing steps and compression and decompression processing is performed in each processing step. Techniques of such compression and decompression processing may differ from each other and sufficient management as to how each compression and decompression technique causes the image quality of image data to be degraded cannot be conducted.

For example, JPEG (Joint Photographic Experts Group) is often used as a compression technique of a still image.

However, there is a problem of accumulation of image quality degradation if compression and decompression processing of image data is repeated according to an irreversible compression technique such as JPEG.

Then, the following method is proposed: To decompress compressed image data, perform image processing for a part of the image data, and again compress the image data subjected to the image processing, only the image data of the portion subjected to the image processing is again compressed and the image data before being decompressed (in compression state) is adopted for other portions for lessening the area to be again compressed, thereby decreasing image quality degradation. (For example, refer to JP-A-9-139846.)

### SUMMARY OF THE INVENTION

It is therefore an object of the invention to provide an image processing system, an image formation apparatus, and a program for making it possible to decrease image quality degradation caused by repeating compression processing and decompression processing of image data.

To the end, according to the invention, there is provided an image processing system including an image data transmission terminal and an image formation apparatus, the image processing system having a filtering section for performing filtering for image data; a coding section for performing reversible coding processing for the image data subjected to the filtering by the filtering section; and a decompression section for performing decompression processing for the image data subjected to the coding processing by the coding section, wherein the filtering of the filtering section changes the pixel value of image data so as to be fitted for the coding processing of the coding section.

According to the invention, there is provided an image processing system including an image data transmission terminal and an image formation apparatus, wherein the image data transmission terminal has a filtering section for performing filtering for image data; a coding section for performing reversible coding processing for the image data subjected to the filtering by the filtering section; and a transmission section for transmitting the image data subjected to the coding processing by the coding section to the image formation apparatus, wherein the image formation apparatus has a reception section for receiving the image data from the image data transmission terminal; and a decompression section for performing decompression processing for the image data received by the reception section, and wherein the filtering of the filtering section changes the pixel value of image data so as to be fitted for the coding processing of the coding section.

According to the invention, there is provided an image processing system including an image data transmission terminal and an image formation apparatus, wherein the image data transmission terminal has a filtering section for performing filtering for image data; and a transmission section for transmitting the image data subjected to the filtering by the filtering section to the image formation apparatus, wherein the image formation apparatus has a reception section for receiving the image data from the image data transmission terminal; a coding section for performing reversible coding processing for the image data received by the reception section; and a decompression section for performing decompression processing for the image data subjected to the coding processing by the coding section, and wherein the filtering of the filtering section changes the pixel value of image data so as to be fitted for the coding processing of the coding section.

Preferably, the filtering section performs filtering corresponding to the algorithm of the coding processing of the coding section.

Preferably, the image processing system further has an edit section for performing edit processing for the image data decompressed by the decompression section; a re-coding section for performing coding processing for the image data subjected to the edit processing; a re-decompression section for performing decompression processing for the image data subjected to the coding processing by the re-coding section; and an image formation section for forming an image based on the image data decompressed by the re-decompression section.

Preferably, to perform coding processing for an attention pixel unit in the image data, the coding section references the pixel value of a pixel unit at a preset position and performs coding processing.

Preferably, as the filtering, the filtering section changes the pixel value of the attention pixel unit so as to raise the probability that the pixel value of the attention pixel unit will match the pixel value of the pixel unit at the preset position.

Preferably, the filtering section changes the pixel value of the attention pixel unit in response to the spatial frequency of the image data.

Preferably, as the filtering, the filtering section changes the pixel value of the attention pixel unit in the image data so as to decrease the code amount of coding of the coding section and distributes the change amount produced by changing the pixel value to peripheral pixels, and the coding section codes the pixel value changed by the filtering.

Preferably, the image processing system further has a parameter generation section for generating a filter parameter in response to a specified compression ratio, wherein the filtering section performs the filtering in response to the generated filter parameter.

Preferably, the parameter generation section generates the filter parameter in response to the speed at which data can be transferred to the image formation apparatus or the operation state of the image formation apparatus.

Preferably, the image formation apparatus further has a re-filtering section for performing the filtering for the image data subjected to the edit processing by the edit section in response to the type of edit processing or the operation state of the image formation apparatus.

According to the invention, there is provided an image formation apparatus having a reception section for receiving image data subjected to filtering; a coding section for performing reversible coding processing for the image data received by the reception section; a decompression section for performing decompression processing for the image data subjected to the coding processing by the coding section; an edit section for performing edit processing for the decompressed image data; are-coding section for performing reversible coding processing for the image data subjected to the edit processing; a re-decompression section for performing decompression processing for the image data subjected to the coding processing by the re-coding section; and an image formation section for forming an image based on the image data decompressed by the re-decompression section.

According to the invention, there is provided an image formation apparatus having a reception section for receiving image data subjected to filtering and reversible coding processing; a decompression section for performing decompression processing for the image data received by the reception section; an edit section for performing edit processing for the decompressed image data; a re-coding section for performing reversible coding processing for the image data subjected to the edit processing; a re-decompression section for performing decompression processing for the image data subjected to the coding processing by the re-coding section; and an image formation section for forming an image based on the image data decompressed by the re-decompression section.

According to the invention, there is provided an image formation apparatus having a filtering section for performing filtering for image data; a coding section for performing reversible coding processing for the image data subjected to the filtering by the filtering section; a decompression section for performing decompression processing for the image data subjected to the coding processing by the coding section; an edit section for performing edit processing for the decompressed image data; are-coding section for performing reversible coding processing for the image data subjected to the edit processing; a re-decompression section for performing decompression processing for the image data subjected to the coding processing by the re-coding section; and an image formation section for forming an image based on the image data decompressed by the re-decompression section.

According to the invention, there is provided an image processing method for repeating coding processing and decompression processing of image data, the method including the steps of performing filtering of changing the pixel value so as to fit for reversible coding processing for image data by a computer; performing reversible coding processing for the image data subjected to the filtering by the computer; and performing decompression processing for the image data subjected to the coding processing by the computer.

According to the invention, there is provided, in an image processing system including an image data transmission terminal including a computer and an image formation apparatus, a program for causing the computer of the image data transmission terminal to execute the steps of performing filtering of changing the pixel value so as to fit for reversible coding processing for image data; and transmitting the image data subjected to the filtering to the image formation apparatus.

According to the invention, there is provided, in an image processing system including an image data transmission terminal including a computer and an image formation apparatus, a program for causing the computer of the image data transmission terminal to execute the steps of performing filtering of changing the pixel value so as to fit for reversible coding processing for image data; performing reversible coding processing for the image data subjected to the filtering; and transmitting the image data subjected to the coding processing to the image formation apparatus.

Next, specific examples of the filtering and the coding processing will be discussed. The examples given below are intended for embodying the invention and aiding in understanding the invention and are not intended for limiting the technical scope of the invention.

The filtering section has a pixel value change section for changing the pixel value of an attention pixel in the image data and an error distribution section for distributing the error value produced in the pixel value change section to peripheral pixels, and the coding section codes the pixel value changed by the pixel value change section. The pixel value change section changes the pixel value so as to decrease the code amount in an image coding section.

The image coding section performs, for example, reversible coding and more particularly prediction coding.

The pixel value change section may change the pixel value only if prediction of the image coding section does not come true.

The error distribution section distributes the error value by an error diffusion method, for example. The error distribution section may distribute the error by a least mean error method.

The pixel value change section does not execute change causing an error value of a preset value or more to occur.

The pixel value change section predicts the pixel value of the attention pixel using the same prediction section as the prediction section of the image coding section, and changes the pixel value of the attention pixel to the prediction pixel value. The image coding section may execute coding after pixel value change is made for the whole image or each time pixel value change is made for a part of the image.

More specifically, the image coding section includes an image input section for inputting an image, a plurality of pixel value prediction sections for predicting the pixel value of the attention pixel to be coded in the image input through the image input section according to different prediction techniques, a prediction error calculation section for calculating the error between the pixel value of the attention pixel in the image input through the image input section and the prediction value provided according to predetermined prediction technique, a match determination section for determining whether or not each of the pixel values predicted by the plurality of pixel value prediction sections matches the pixel value of the attention pixel, a selection section for outputting alternatively the identification information for identifying the pixel value prediction section predicting the pixel value matching the pixel value of the attention pixel, determined by the match determination section based on the determination output of the match determination section and the error calculated by the prediction error calculation section, an error coding section for coding the identification information and the error output by the selection section, and an output section for outputting the code provided by the coding section.

The attention pixel section one or more pixels contained in the image, namely, a pixel unit on which attention is focused as the processing target (attention pixel unit).

The image formation apparatus has the image coding section and an image decompression section for decoding the code output by the image coding section.

The filtering section may perform filtering in response to the spatial frequency in an image and the visual characteristic of a human being.

For example, the filtering section changes the pixel value of the attention pixel in the image data to be processed according to a predetermined condition relative to the spatial frequency, and the coding section performs predetermined coding processing for the image data with the pixel value changed to generate code data.

Specifically, the filtering section retains MTF characteristic curve information defining the limit of contrast sensitivity of the naked eye for each spatial frequency, divides the image data to be processed into pixel groups each of a predetermined size, adopts each pixel contained in the pixel group as an attention pixel, calculates the spatial frequency determined in relation to the pixel value of each attention pixel, a predetermined visual range, and the size of the pixel group, references the MTF characteristic curve information, and acquires the limit of contrast sensitivity of the naked eye at the calculated spatial frequency as the limit contrast. If the pixel value ratio between the attention pixels is within the acquired limit contrast, the filtering section changes the pixel value of each attention pixel to the pixel value determined in relation to at least one of the pixel values of the attention pixels.

More specifically, the filtering section retains MTF characteristic curve information defining the limit of contrast sensitivity of the naked eye for each spatial frequency, divides the image data to be processed into pixel groups each of a predetermined size, adopts each pixel contained in the pixel group as an attention pixel, calculates the spatial frequency determined in relation to the pixel value of each attention pixel, a predetermined visual range, and the size of the pixel group, references the MTF characteristic curve information, acquires the limit of contrast sensitivity of the naked eye at the calculated spatial frequency as the limit contrast, calculates the target value of the pixel value of each attention pixel in relation to at least one of the pixel values of the attention pixels, and changes the pixel value of each attention pixel so as to approach the target value within the acquired limit contrast.

The filtering section retains MTF characteristic curve information defining the limit of contrast sensitivity of the naked eye for each spatial frequency and a. may divide the image data to be processed into pixel groups each of a predetermined initial size, b. may adopt each pixel contained in the pixel group as an attention pixel and calculate the spatial frequency determined in relation to the pixel value of each attention pixel, a predetermined visual range, and the size of the pixel group, and c. may reference the MTF characteristic curve information and acquire the limit of contrast sensitivity of the naked eye at the calculated spatial frequency as the limit contrast. If the pixel value ratio between the attention pixels is within the acquired limit contrast, the filtering section further d. may increase the size of the pixel group by predetermined increment size and e. may repeat steps b to d. and define the pixel group of the maximum size such that the pixel value difference between the attention pixels is within the acquired limit contrast, and change the pixel value of each attention pixel contained in the defined pixel group to the correction pixel value determined in relation to at least one of the pixel values of the attention pixels contained in the defined pixel group.

### BRIEF DESCRIPTION OF THE DRAWINGS

These and other objects and advantages of this invention will become more fully apparent from the following detailed description taken with the accompanying drawings in which:

FIG. 1 is a drawing to describe an outline of an image processing system 2 according to the invention;

FIG. 2 is a drawing to illustrate the hardware configuration of a printer 20 (image formation apparatus) centering on a controller 200;

FIG. 3 is a diagram to describe the functional configuration of a printer driver 5 (client terminal 12) and an image formation program 6 (printer 20);

FIG. 4 is a diagram to describe the functional configuration of a filtering section 510 and a reversible compression section 520 in more detail;

FIG. 5 is a flowchart of image formation processing performed in the image processing system 2 (S10);

FIG. 6 is a flowchart to describe filtering (S110) and reversible compression processing (S120) in the flowchart of FIG. 5 in more detail;

FIG. 7 is a diagram to describe the functional configuration of a second printer driver 52 and a second image formation program 62;

FIG. 8 is a flowchart to describe the operation of the second printer driver 52 and the image formation program 62 (S20);

FIG. 9 is a diagram to describe the functional configuration of a third printer driver 54 and a third image formation program 64 for performing filtering and parameter generation processing in a printer 20;

FIG. 10 is a flowchart to describe the operation of an image generation section 620 in the third image formation program 64 (S150);

FIG. 11 is a diagram to describe the functional configuration of a filtering 510 for performing filtering responsive to the visual characteristic of a human being;

FIG. 12 is a drawing to show an MTF characteristic curve;

FIG. 13 is a diagram to describe the functional configuration of a printer driver 56 and an image formation program 66 for a printer 20 to perform filtering;

FIG. 14 is a diagram to describe the functional configuration of a printer driver 57 and an image formation program 67 for an image data transmission terminal to perform filtering and transmit image data to a printer 20; and

FIG. 15 is a diagram to describe the functional configuration of a printer driver 58 and an image formation program 68 for an image processing section 640 to again perform filtering.

### DETAILED DESCRIPTION OF THE PREFERRED EMBODIMENTS

An image processing system according to the invention locates an irreversible portion in coding processing and manages the irreversible portion, thereby controlling the image quality degradation amount in the image processing. That is, the image processing system limits the number of processing times and the processing of the irreversible portion in the coding processing and allows repetitions of a reversible portion (reversible coding). For example, the image processing system according to the invention realizes coding at a high compression ratio in irreversible filtering and reversible coding processing and allows repetitions of reversible coding processing and reversible decompression processing, thereby decreasing accumulation of image quality degradation. The image processing system controls a parameter of irreversible filtering, thereby controlling the image quality in the image processing including a plurality of processing steps.

The reversible coding processing often involves a low compression ratio as compared with the irreversible coding processing. However, the image processing system according to the invention performs filtering for enhancing the compression ratio of later coding processing as preprocessing of the coding processing for achieving a sufficient compression ratio.

[First Embodiment]

A first embodiment of the invention will be discussed.

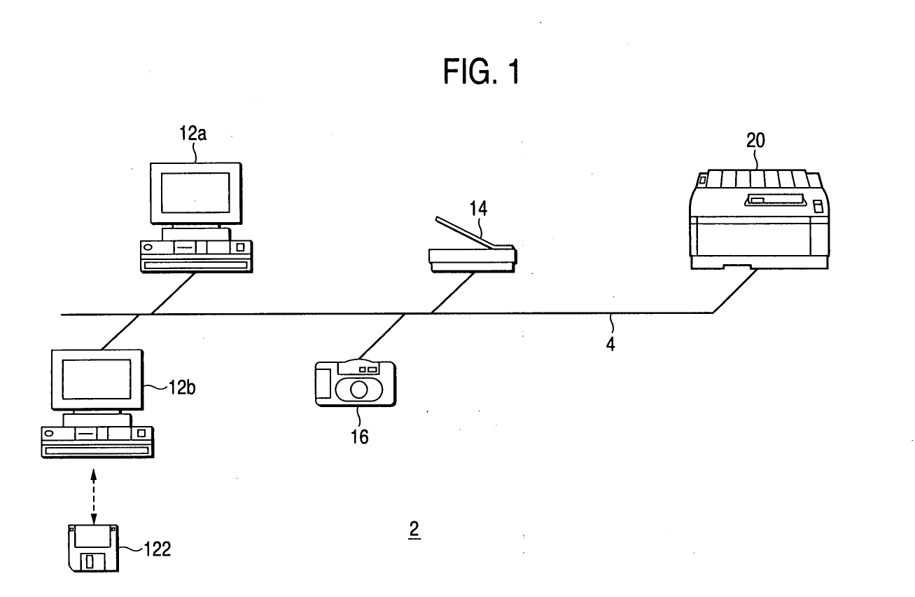

FIG. 1 is a drawing to describe an outline of an image processing system 2 according to the invention.

As shown in FIG. 1, the image processing system 2 is made up of image data transmission terminals such as client terminals 12 (12a and 12b), a scanner 14, and a digital camera 16 and a printer 20, the components being connected through a network 4. The image data transmission terminals transmit image data to the printer 20 and request the printer 20 to print the image data.

The client terminals 12a and 12b, which are computer terminals, are connected to the printer 20 through the network 4 implemented as a LAN, etc. The scanner 14 and the digital camera 16 are connected to the printer 20 through a line of a USB cable, etc., (network 4).

A printer driver 5 described later is installed in the client terminals 12, the scanner 14, and the digital camera 16 as software or hardware. For example, the printer driver 5 of the client terminal 12 is installed through a record medium 122 or the network 4.

In the description to follow, the case where the image data transmission terminal is the client terminal 12 is taken as a specific example.

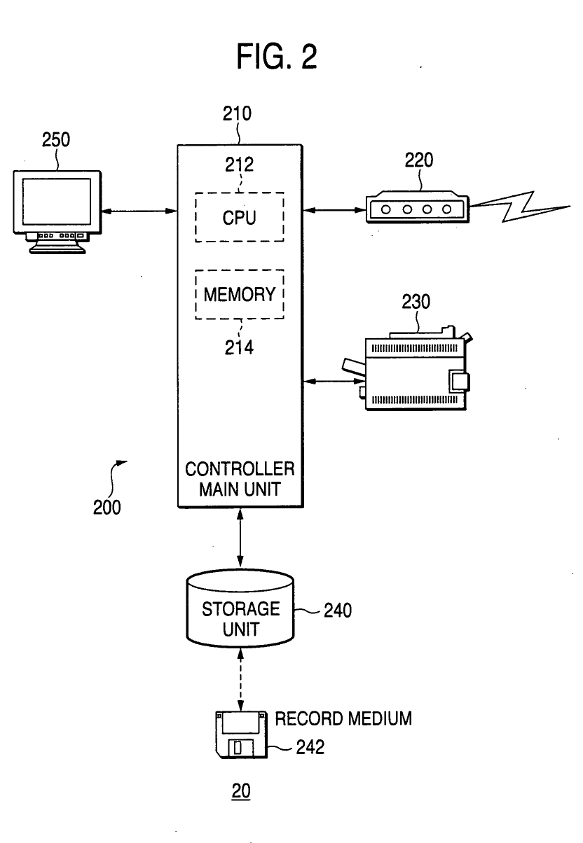

FIG. 2 is a drawing to illustrate the hardware configuration of the printer 20 (image formation apparatus) centering on a controller 200.

As shown in FIG. 2, the printer 20 is made up of the controller 200 and a printer main unit 230. The controller 200 is made up of a controller main unit 210 including a CPU 212, memory 214, and the like, a communication unit 220, a record unit 240 such as an HDD or CD unit, and a user interface unit (UI unit) 250 including an LCD or a CRT display, a keyboard, a touch panel, and the like.

[Printer Driver and Image Formation Program]

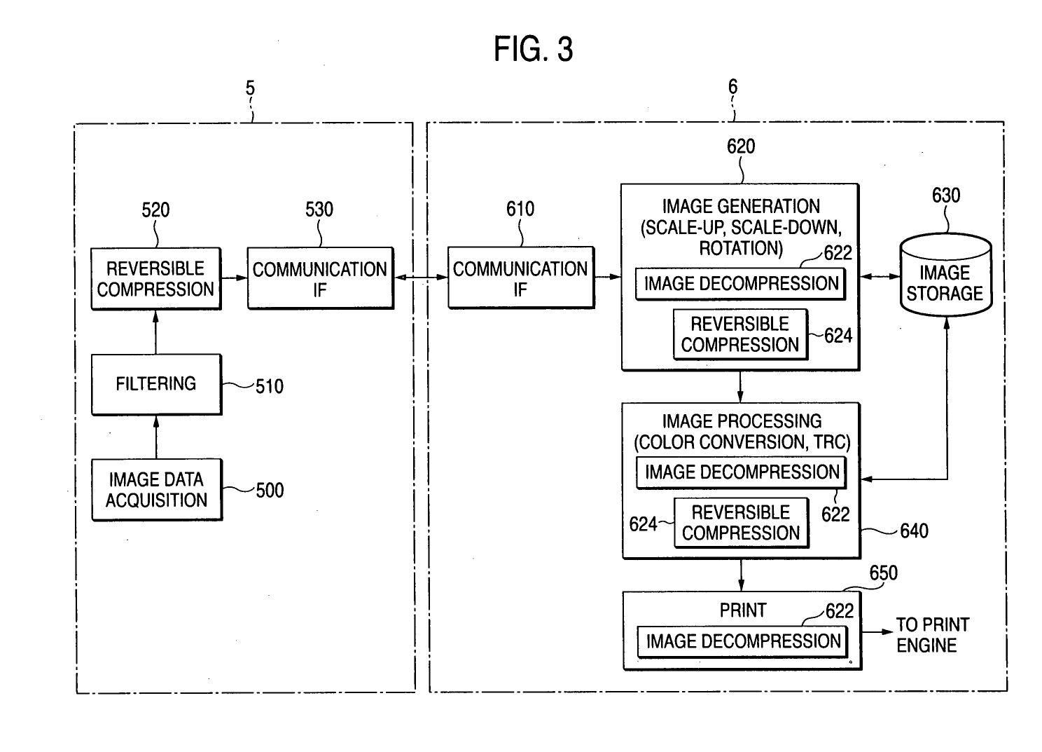

FIG. 3 is a diagram to describe the functional configuration of the printer driver 5 (client terminal 12) and an image formation program 6 (printer 20).

As shown in FIG. 3, the printer driver 5 has an image data acquisition section 500, a filtering section 510, a reversible compression section 520, and a communication interface (communication IF) 530.

The image data acquisition section 500, which is an interface between any other application software and the printer driver 5, acquires image data from image edit application software and outputs the image data to the filtering section 510.

The filtering section 510 performs irreversible filtering for the image data input from the image data acquisition section 500 and outputs the provided image data to the reversible compression section 520. For example, the filtering section 510 performs pixel value change processing to lessen the code amount of coding processing of the reversible compression section 520.

For the reversible compression section 520 to perform prediction coding using a predetermined prediction method (JPEG independent, gzip, LZ coding, JPEG-LS, etc.,), the filtering section 510 changes the pixel value of each pixel so as to enhance the prediction probability of the above-mentioned prediction method. For example, for the reversible compression section 520 to perform universal coding of LZ, etc., the filtering section 510 changes the pixel value of each pixel so as to match long data in a referenced coding dictionary; for the reversible compression section 520 to perform run-length coding, the filtering section 510 changes the pixel values so that the same pixel values are consecutive. For the reversible compression section 520 to perform arithmetic coding, the filtering section 510 changes the pixel value of each pixel so that a dominant (high occurrence probability) symbol is provided in the arithmetic coding.

In this case, the filtering section 510 changes the pixel values of the pixels contained in the image data to such an extent that the image data can be visually recognized as an image, and thus can display the post-filtered image data for the user to check the image data.

The reversible compression section 520 performs reversible coding processing for the image data input from the filtering section 510 for converting the image data into code data. That is, the reversible compression section 520 reversibly compresses the image data subjected to the filtering by the filtering section 510 and outputs the provided data to the communication IF 530.

The communication IF 530 controls transmission and reception of data in the network 4 and transmits the code data input from the reversible compression section 520 to the image formation program 6 (printer 20).

As shown in FIG. 3, the image formation program 6 has a communication IF 610, an image generation section 620 (an edit section), an image storage section 630, an image processing section 640 (an edit section), and a print section 650 (an image formation section). The image formation program 6 in the embodiment is software installed in the printer 20 via a record medium 242, but the functions of the image formation program 6 may be implemented as hardware such as an ASIC.

The communication IF 610 receives the code data transmitted from the printer driver 5 (client terminal 12) and outputs the code data to the image generation section 620.

The image generation section 620 has an image decompression section 622 and a reversible compression section 624. The image decompression section 622 decodes the code data input from the communication IF 610 to convert the code data into image data.

The image generation section 620 performs edit processing of image scale-up, scale-down, 90-degree rotation, and the like for the provided image data.

The reversible compression section 624 again codes the image data subjected to the edit processing into code data according to a reversible coding technique, and outputs the code data to the image storage section 630 or the image processing section 640.

The reversible compression section 624 may use a different coding technique from that of the reversible compression section 520 of the printer driver 5, but needs to use a coding technique responsive to the filtering of the filtering section 510. That is, the reversible compression section 624 needs to use a coding technique capable of sufficiently lessening the code amount as the filtering section 510 changes the pixel values.

For example, for the reversible compression section 520 of the printer driver 5 to perform run-length coding, the filtering section 510 changes the pixel values so that runs are consecutive and thus the reversible compression section 624 references peripheral pixels and predicts the pixel values as prediction coding, etc. For the reversible compression section 520 of the printer driver 5 to perform prediction coding, it is desirable that the reversible compression section 624 should perform prediction coding using the same prediction method.

The image storage section 630 stores the code data input from the image generation section 620 or the image processing section 640 and outputs the code data as requested. For example, if the image generation section 620 or the image processing section 640 requires a work area to process any other image data, for example, the image storage section 630 writes the code data into nonvolatile memory such as an HD for reserving a work area. In this case, since the record area of the HD, etc., is limited, the image data written into the record area of the HD, etc., in a compression state (again coded).

The image generation section 620 may access the code data stored in the image storage section 630, decode the code data, and repeat edit processing.

The image processing section 640 also has an image decompression section 622 and a reversible compression section 624 like the image generation section 620, and when the image decompression section 622 decodes the code data input from the image generation section 620 into image data, the image processing section 640 performs correction processing of color conversion, TRC processing, etc.

The reversible compression section 624 again codes the image data subjected to the color conversion, TRC processing, etc., into code data according to a reversible coding technique and outputs the code data to the image storage section 630 or the print section 650.

The print section 650 has an image decompression section 622 and when the image decompression section 622 decodes the code data input from the image processing section 640 into image data, the print section 650 controls a print engine (not shown) of the printer main unit 230 to print an image based on the provided image data.

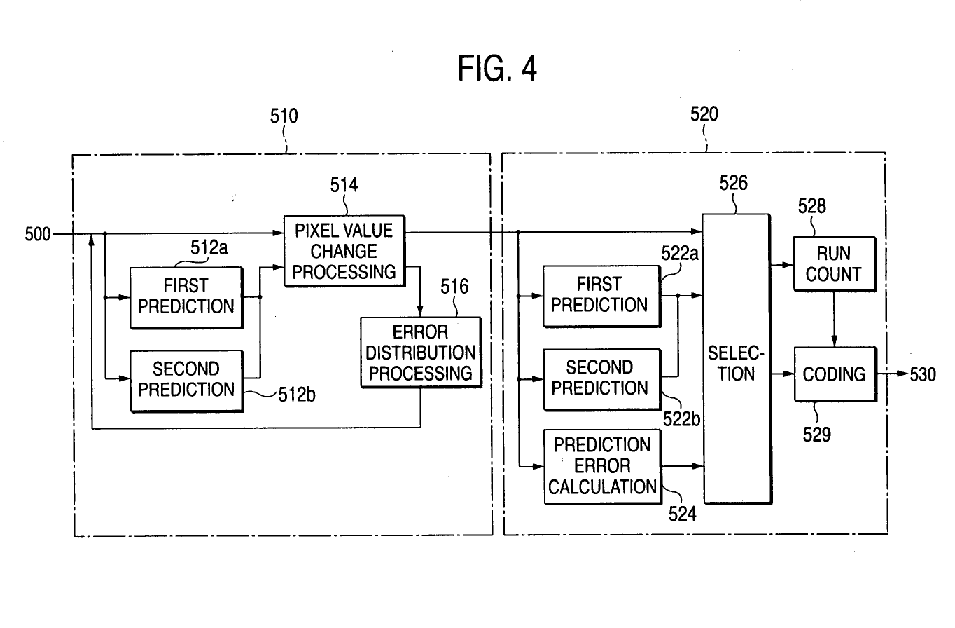

FIG. 4 is a diagram to describe the functional configuration of the filtering section 510 and the reversible compression section 520 in more detail.

As shown in FIG. 4, the filtering section 510 has a first prediction section 512a, a second prediction section 512b, a pixel value change processing section 514, and an error distribution processing section 516. In the embodiment, the mode wherein the two prediction sections 512 (first prediction section 512a and second prediction section 512b) are included is described, but the number of the prediction sections 512 may be one or more; for example, five prediction sections 512 may be included.

Each of the first prediction section 512a and the second prediction section 512b predicts the pixel value of the attention pixel based on the image data according to a predetermined technique and outputs the pixel value to the pixel value change processing section 514 as the prediction value. For example, the first prediction section 512a and the second prediction section 512b reference the pixel values of pixels at different positions and predict the pixel value of the attention pixel.

The pixel value change processing section 514 makes a comparison between the pixel value of the attention pixel and the prediction value. If the difference there between is smaller than a preset value, the pixel value change processing section 514 outputs the prediction value to the reversible compression section 520 and further outputs the difference between the pixel value of the attention pixel and the prediction value, which will be hereinafter referred to as error value, to the error distribution processing section 516. On the other hand, if the difference between the pixel value of the attention pixel and the prediction value is equal to or greater than the preset value, the pixel value change processing section 514 outputs the pixel value of the attention pixel intact to the reversible compression section 520 and outputs 0 to the error distribution processing section 516. That is, the filtering section 510 does not make error distribution of the error value equal to or greater than the preset value.

The error distribution processing section 516 generates an error distribution value based on the error value input from the pixel value change processing section 514, and adds the error distribution value to the pixel value of a predetermined pixel contained in the image data. The error distribution value is calculated by multiplying the error value by a weight matrix value according to an error diffusion method or a least mean error method using a weight matrix, for example.

Thus, the filtering section 510 in the embodiment changes the pixel values contained in the image data so that the reversible compression section 520 described later easily compresses the image data. At the time, the filtering section 510 distributes the difference from the true pixel value produced by changing the pixel value to the peripheral pixels for making the pixel value change macroscopically inconspicuous.

As shown in FIG. 4, the reversible compression section 520 has a first prediction section 522a, a second prediction section 522b, a prediction error calculation section 524, a selection section 526, a run count section 528, and a coding section 529.

Almost like the first prediction section 512a and the second prediction section 512b, each of the first prediction section 522a and the second prediction section 522b predicts the pixel value of the attention pixel based on the image data according to a predetermined technique and outputs the pixel value to the selection section 526 as the prediction value.

The prediction error calculation section 524 predicts the pixel value of the attention pixel based on the image data according to a predetermined technique, subtracts the prediction value from the actual pixel value of the attention pixel, and outputs the result to the selection section 526 as the prediction error value.

The selection section 526 detects match or mismatch of the prediction in the attention pixel from the image data and the prediction value. If the first or second prediction section 522a or 522b makes right prediction as the result of the detection, the selection section 526 outputs the identification number of the prediction section 522 making the right prediction to the run count section 528 and the coding section 529; if neither the first nor the second prediction section 522 makes right prediction, the selection section 526 outputs the prediction error value to the run count section 528 and the coding section 529.

If the identification number indicates the first prediction section 522a, the run count section 528 increments an internal counter by one. If the identification number does not indicate the first prediction section 522a and the internal counter is not 0, the run count section 528 outputs the value of the internal counter to the coding section 529 as the run data.

If the run data and the prediction error value are given at the same time, the coding section 529 first codes the run data and then codes the prediction error value. On the other hand, if only the identification number or the prediction error value is given, the coding section 529 codes the identification number or the prediction error value.

The coding processing of the run count section 528 and the coding section 529 is a mode assuming that the hit probability of the first prediction section 522a is high, but any other coding method may be used. For example, if fixed-length code is given for the purpose of high-speed decoding, etc., the coding section 529 codes a signal indicating that the first prediction section 522a makes right prediction as binary number “01,” a signal indicating that the second prediction section 522b makes right prediction as binary number “10,” or a signal indicating that neither the first nor the second prediction section makes right prediction as binary number “00,” and codes the prediction error as code plus eight-bit binary number. To enhance the compression ratio, the coding section 529 may code using variable-length coding such as arithmetic coding. For example, for Huffman code with one-bit code given to the first prediction section 522a where the occurrence probability seems to be high, the coding section 529 codes a signal indicating that the first prediction section 522a makes right prediction as binary number “00,” a signal indicating that the second prediction section 522b makes right prediction as binary number “10,” or a signal indicating that neither the first nor the second prediction section 522 makes right prediction as binary number “11.” The coding section 529 may code using arithmetic coding. Thus, several coding techniques are possible.

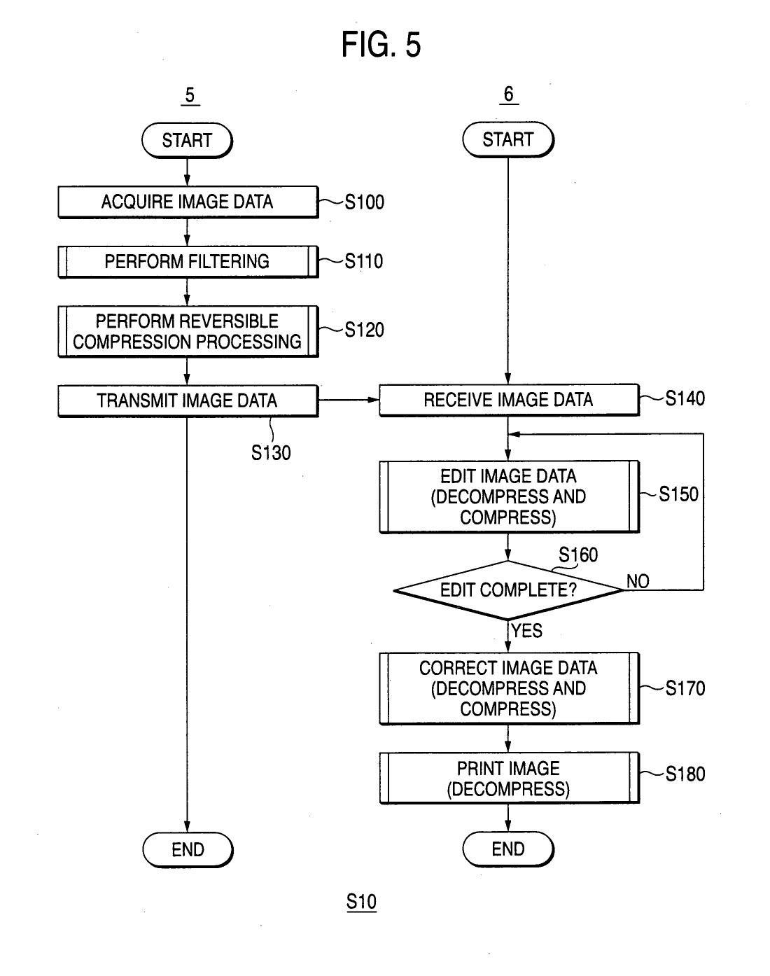

FIG. 5 is a flowchart of image formation processing performed in the image processing system 2 (S10).

As shown in FIG. 5, if the user enters a command for printing edited image data at the client terminal 12a, at step 100 (S100), the image data acquisition section 500 in the printer driver 5 receives the image data from the application program editing the image data and outputs the image data to the filtering section 510.

At step 110 (S110), the filtering section 510 performs irreversible filtering for the image data and outputs the provided image data to the reversible compression section 520.

At step 120 (S120), the reversible compression section 520 performs reversible filtering for the image data to convert the image data into code data, and outputs the code data to the communication IF 530.

At step 130 (S130), the communication IF 530 transmits the code data through the network 4 to the image formation program 6 (printer 20).

At step 140 (S140), the communication IF 610 in the image formation program 6 receives the code data from the printer driver 5 through the network 4 and outputs the code data to the image generation section 620.

At step 150 (S150), the image decompression section 622 in the image generation section 620 decodes the code data. The image generation section 620 performs image edit processing for the image data provided by decoding the code data. The reversible compression section 624 in the image generation section 620 again converts the image data subjected to the edit processing into code data using the reversible coding technique.

At step 160 (S160), the image generation section 620 determines whether all edit processing for the image data is complete. If it is determined that the edit processing is all complete, the image formation program 6 outputs the code data to the image processing section 640 and goes to step 170; otherwise, the code data is once stored in the image storage section 630 and step 150 is repeated using the stored code data.

At step 170 (S170), the image decompression section 622 in the image processing section 640 decodes the code data into image data. The image processing section 640 performs correction processing for the provided image data so that the image data is fitted for print. The reversible compression section 624 in the image processing section 640 again codes the image data subjected to the correction processing into code data using the reversible coding technique, and outputs the code data to the print section 650.

At step 180 (S180), the image decompression section 622 in the print section 650 decodes the code data into image data. The print section 650 controls the print engine of the printer main unit 230 to print an image responsive to the provided image data.

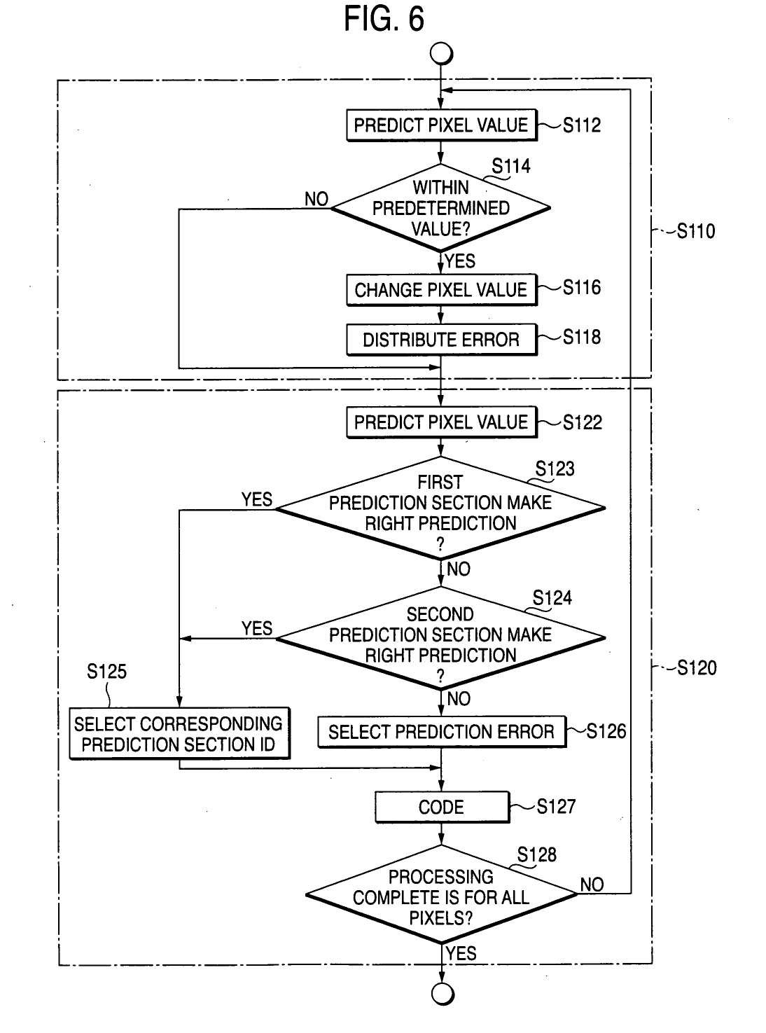

FIG. 6 is a flowchart to describe the filtering (S110) and the reversible compression processing (S120) in the flowchart of FIG. 5 in more detail.

As shown in FIG. 6, at step 112 (S112), the first prediction section 512a and the second prediction section 512b in the filtering section 510 set one of the pixels contained in the image data to the attention pixel in the order of the scan lines (lateral or longitudinal direction of image or the like), references the pixel vales of peripheral pixels surrounding the attention pixel, predicts the pixel value of the attention pixel, and outputs the prediction value to the pixel value change processing section 514.

At step 114 (S114), the pixel value change processing section 514 determines whether or not the difference between the pixel value of the attention pixel and the prediction value is within a preset value. If the difference between the pixel value and the prediction value is within the preset value, the printer driver 5 goes to S116; otherwise, the printer driver 5 goes to S122.

At step 116 (S116), the pixel value change processing section 514 outputs the prediction value nearest to the pixel value of the attention pixel to the reversible compression section 520 as the pixel value of the attention pixel, and outputs the difference between the actual pixel value of the attention pixel and the nearest prediction value to the error distribution processing section 516.

At step 118 (S118), the error distribution processing section 516 distributes the difference between the pixel value of the attention pixel and the nearest prediction value to the peripheral pixels.

At step 122 (S122), the first prediction section 522a and the second prediction section 522b in the reversible compression section 520 predict the pixel value input from the pixel value change processing section 514. The prediction error calculation section 524 calculates the difference between the prediction value provided by the predetermined prediction section 522 and the actual pixel value, and outputs the difference to the selection section 526 as the prediction error value.

In the filtering section 510, if the pixel value change processing section 514 changes the pixel value of the attention pixel to the prediction value provided by the first prediction section 512a, the prediction of the first prediction section 522a comes true; if the pixel value change processing section 514 changes the pixel value of the attention pixel to the prediction value provided by the second prediction section 512b, the prediction of the second prediction section 522b comes true. That is, as the filtering section 510 performs filtering, the prediction probability of the reversible compression section 520 is improved. Therefore, the compression ratio of the coding processing performed by the reversible compression section 520 can be enhanced.

The selection section 526 determines which prediction section 522 makes right prediction. If the first prediction section 522a makes right prediction (YES at S123), the selection section 526 outputs the identification information of the first prediction section 522a to the run count section 528 (S125). If the second prediction section 522b makes right prediction (NO at S123 and YES at S124), the selection section 526 outputs the identification information of the second prediction section 522b to the run count section 528 and the coding section 529 (S125). If neither the first nor the second prediction section 522 makes right prediction (NO at S123 and NO at S124), the selection section 526 outputs the prediction error value calculated by the prediction error calculation section 524 to the run count section 528 and the coding section 529 (S126).

At step 127 (S127), the coding section 529 codes the run information of the first prediction section 522a, the identification information of the second prediction section 522b, or the prediction error value and outputs the coded information to the communication IF 530.

At step 128 (S128), the printer driver 5 determines whether or not the processing is complete for all image data. If the printer driver 5 determines that the processing is complete for all image data, the printer driver 5 completes S110 and S120; otherwise, the printer driver 5 returns to S112 and executes steps S112 to S127 for the next pixel on the scan line.

In the example, the mode in which filtering and reversible coding processing are performed for each pixel has been described, but filtering and reversible coding processing maybe performed for each pixel unit consisting of pixels. After the filtering is complete for all pixels, the reversible coding processing may be performed.

Thus, in the printer 20, the band of the printer path for internally transferring the image data is limited and the image data is transmitted and received in the compression state (coded). Thus, the printer 20 repeats compression processing and decompression processing of the image data.

Since the printer 20 in the embodiment repeats compression and decompression of the image data after subjected to the filtering using the reversible coding technique, accumulation of image quality degradation can be prevented. The filtering in the embodiment is well suited to the reversible coding technique, so that the client terminal 12 can provide a sufficient compression ratio using the filtering processing and the reversible coding processing in combination. Further, the easy-to-code nature produced by performing the filtering is not lost if processing of image scale-up, scale-down, 90-degree rotation, color conversion, TRC, etc., is performed for the image data. Thus, in the printer 20 in the embodiment, the image data can be sufficiently compressed by reversible coding even after image edit processing, correction processing, etc., is performed.

Thus, according to the image processing system 2 in the embodiment, irreversible processing causing the image quality to be degraded is located, whereby it becomes easy to control the image quality of the final image to be printed. That is, in the example, only the filtering of the filtering section 510 is controlled, whereby the image quality degradation amount can be controlled.

[Modification]

The degree of irreversible processing by the filtering may be controlled dynamically. For example, a filtering parameter (filter parameter) may be changed in response to the compression ratio desired by the user. The filter parameter may be changed in response to the operation state of the network 4 and the printer 20 (for example, the available band of the printer path). In this case, the filter parameter is a variable for controlling the filtering and is also a variable for controlling the compression ratio of image data and the image quality degradation amount. The filter parameter is the above-described preset value used as the reference to determine whether or not the pixel value change processing section 514 is to change the pixel value, for example. In this case, as the preset value is increased, if the difference between the actual pixel value and the prediction value provided by the prediction section 512 is large, the prediction value is adopted and the image quality degradation amount grows; on the other hand, the probability that the prediction section 522 of the reversible compression section 520 will make right prediction rises and therefore the compression ratio is enhanced. The filter parameter is thus controlled, whereby it is made possible to provide the compression ratio and the image quality responsive to the requirement.

[Second Embodiment]

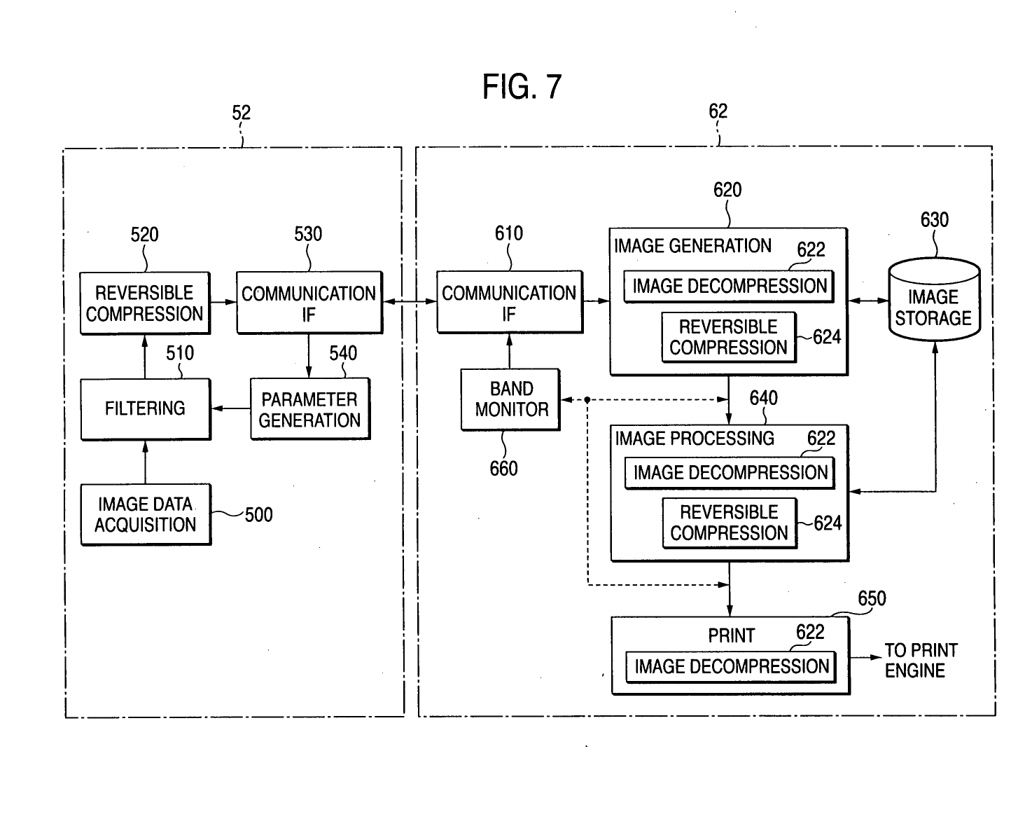

FIG. 7 is a diagram to describe the functional configuration of a second printer driver 52 and a second image formation program 62. Components substantially identical with those previously described with reference to FIG. 3 are denoted by the same reference numerals in FIG. 7.

As shown in FIG. 7, the printer driver 52 has a parameter generation section 540 in addition to the components of the printer driver 5 previously described with reference to FIG. 3.

The parameter generation section 540 generates a filter parameter in response to the compression ratio requested by the user, the band information of a network 4, the band information of the printer path provided in a printer 20, or the like, and outputs the filter parameter to a filtering section 510. In the example, the case where the parameter generation section 540 generates a filter parameter in response to the band information of the printer path for dynamically controlling the filtering section 510 will be discussed as a specific example. Here, the printer path is a signal line for connecting a CPU 212 and memory 214 of a controller main unit 210, the interfaces of a printer main unit 230, a record unit 240, etc., and the like.

The image formation program 62 has a band monitor section 660 in addition to the components of the image formation program 6 previously described with reference to FIG. 3.

The band monitor section 660 monitors the band of the printer path and transmits the band information indicating the use state of the band, etc., through a communication IF 610 and a communication IF 530 to the parameter generation section 540. In the example, the band monitor section 660 monitors the path between an image generation section 620 and an image processing section 640 and the path between the image processing section 640 and a print section 650.

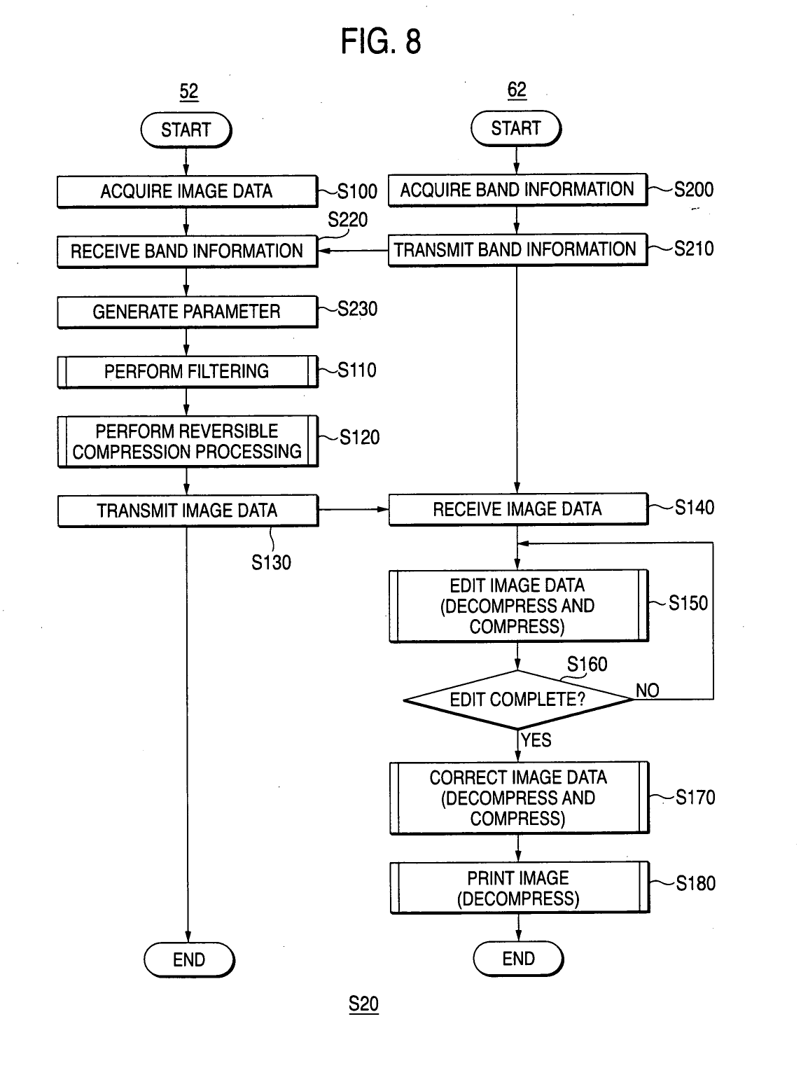

FIG. 8 is a flowchart to describe the operation of the second printer driver 52 and the image formation program 62 (S20). Steps substantially identical with those previously described with reference to FIG. 5 are denoted by the same reference numerals in FIG. 8.

As shown in FIG. 8, at step 200 (S200), the band monitor section 660 of the image formation program 62 monitors the band of the printer path at a predetermined timing and outputs the band information to the communication IF 610.

At step 210 (S210), the communication IF 610 transmits the band information input from the band monitor section 660 through the network 4 to the printer driver 52.

At step 220 (S220), the communication IF 530 of the printer driver 52 receives the band information through the network 4 and outputs the band information to the parameter generation section 540.

At step 230 (S230), the parameter generation section 540 generates a filter parameter in response to the band information input from the communication IF 530 and outputs the filter parameter to the filtering section 510.

At step 110 (S110), the filtering section 510 performs filtering for the image data in response to the filter parameter input from the parameter generation section 540.

Thus, according to the second printer driver 52 and the image formation program 62, the image processing system 2 can change the compression ratio dynamically in response to the band of the printer path and if change occurs in the band state of the printer path, the image processing system 2 can maintain the print speed, etc.

[Third Embodiment]

In the modification described above, the band information needs to be transmitted and received through the network 4. Thus, if the band of the printer path fluctuates in a short period or if the band of the network 4 does not involve a margin, the system in the modification may be unable to sufficiently deal with the situation. In such a case, the filtering, parameter generation, and an band monitor section may be provided in the printer 20.

FIG. 9 is a diagram to describe the functional configuration of a third printer driver 54 and a third image formation program 64 for performing filtering and parameter generation processing in a printer 20. Components substantially similar to those previously described with reference to FIG. 7 are denoted by the same reference numerals in FIG. 9.

As shown in FIG. 9, the image formation program 64 has a filtering section 626 (a re-filtering section) and a parameter generation section 670 in addition to the components of the image formation program 62 previously described with reference to FIG. 7.

The filtering section 626 performs filtering for image data in response to a filter parameter input from the parameter generation section 670.

A band monitor section 660 in the example monitors the record area of an image storage section 630 in addition to the band of the printer path, and outputs the monitor result to the parameter generation section 670 as band information.

The parameter generation section 670 generates a filter parameter in response to the band information and outputs the filter parameter to the filtering section 626.

The filtering section 626 in the example is provided in an image generation section 620; it is also preferred for the image generation section 620 to perform processing to generate a new pixel value. That is, as the image generation section 620 performs image processing for image data, the easy-to-reversibly-compress nature of image data may be destroyed. In such a case, the filtering section 626 of the image generation section 620 again performs filtering for the image data, whereby the reversible compressibility of the image data can be again formed.

The case where the easy-to-reversibly-compress nature is destroyed is, for example, the case where a new pixel value is generated, the case where linear interpolation scale-up, etc., is performed, or the like. On the other hand, the case where the easy-to-reversibly-compress nature is not destroyed is, for example, the case where uniform pixel value change is applied to the whole image or the like, specifically the case where scale-up or scale-down of nearest neighbor interpolation, rotation, color conversion, tone correction (such as TRC), etc., is performed.

FIG. 10 is a flowchart to describe the operation of the image generation section 620 in the third image formation program 64 (S150).

As shown in FIG. 10, at step 152 (S152), an image decompression section 622 of the image generation section 620 decodes code data received from the printer driver 54 into image data.

At step 154 (S154), the image generation section 620 performs edit processing of image scale-up, scale-down (nearest neighbor interpolation), rotation, superimposition, etc., for the provided image data.

At step 155 (S155), the parameter generation section 670 generates a filter parameter in response to the band information input from the band monitor section 660 and outputs the filter parameter to the filtering section 626 (image generation section 620).

At step 156 (S156), the image generation section 620 determines whether filtering is required. If the image generation section 620 determines that filtering is required, it goes to S158; otherwise, it goes to S159. That is, if the filter parameter changes or a new pixel value is generated as edit processing is performed, the image generation section 620 gives a filtering instruction; otherwise, the image generation section 620 executes reversible compression processing without performing filtering. For example, the image generation section 620 determines whether or not filtering is to be performed in response to the type of edit processing.

At step 158 (S158), the filtering section 626 performs filtering for the image data in response to the filter parameter.

At step 159 (S159), a reversible compression section 624 reversibly codes the image data into code data and outputs the image data to the image storage section 630 or an image processing section 640.

Thus, if the band of the printer path or the record area changes rapidly, the image processing system 2 in the example can compress the image data at the compression ratio responsive to the changing band and further if the reversible compressibility of the image data is degraded as edit processing is performed, the image processing system 2 can again perform filtering, thereby providing a sufficient compression ratio.

[Fourth Embodiment]

The compression ratio may be controlled in response to the visual characteristic of a human being. For example, in an area wherein the spatial frequency of an image is high, gradation is hard to distinguish as compared with an area wherein the spatial frequency is low. Then, the pixel value can be changed by filtering in the range in which visual degradation is not involved in response to the spatial frequency of the image and can be coded for improving the efficiency of coding.

FIG. 11 is a diagram to describe the functional configuration of a filtering section 510 for performing filtering responsive to the visual characteristic of a human being. Components substantially identical with those previously described with reference to FIG. 4 are denoted by the same reference numerals in FIG. 11.

As shown in FIG. 11, the filtering section 510 in the example has a change allowance setting section 518 and an MTF characteristic database 519 in addition to the components previously described with reference to FIG. 4.

The change allowance setting section 518 sets change allowance based on the spatial frequency of an image. The change allowance is the limit of the change amount allowed for a pixel value change processing section 514 to change the actual pixel value.

The MTF characteristic database 519 stores numerical data responsive to an MTF (modulation transfer function) characteristic curve as illustrated in FIG. 12. That is, the MTF characteristic database 519 associates the spatial frequency of an image and the limit contract corresponding thereto with each other for storage. Here, the limit contrast is information indicating the maximum gradation that can be distinguished by a human being for the image at a predetermined spatial frequency.

For example, the change allowance setting section 518 calculates spatial frequency f about a pixel group selected as attention pixels, references the MTF characteristic database 519 based on the spatial frequency f to find the limit contrast, references the pixel value of each selected pixel, and finds the amplitude of the pixel values of the attention pixel group. Then, the change allowance setting section 518 calculates the pixel value change allowance based on the limit contrast and the amplitude. In the example, the pixel value change processing section 514 makes a comparison between each prediction value and each attention pixel. If any prediction value exists within the pixel value change allowance in comparison with all attention pixels, the pixel value change processing section 514 increases the number of selected pixels. The pixel value change processing section 514 defines the attention pixel group of the maximum size such that any prediction value exists within the pixel value change allowance in comparison with all attention pixels, and changes the pixel values of the defined attention pixel group to the prediction value existing within the pixel value change allowance in comparison with all attention pixels. At this time, if more than one prediction value satisfies the above-mentioned condition, a condition for choosing which prediction value is predetermined. For example, the prediction value with the smallest square sum of the difference between the prediction value and the pixel value of each attention pixel can also be selected.

Thus, the image processing system 2 in the example performs filtering in response to the visual characteristic of a human being and changes the pixel value of each pixel in the visually indistinguishable range and thus can compress the image data without degrading the image quality at the visual level of the human being.

[Other Modifications]

FIGS. 13, 14, and 15 are diagrams to show modifications wherein the filtering step is changed in the image processing sequence. The filtering step is changed in response to the processing capability of the image data transmission terminal such as the client terminal 12 and the processing capability of the printer 20, an image quality control request, etc.

FIG. 13 is a diagram to describe the functional configuration of a printer driver 56 and an image formation program 66 for a printer 20 to perform filtering. Components substantially identical with those previously described with reference to FIG. 3 are denoted by the same reference numerals in FIG. 13.

The printer driver 56 in the modification is software installed in a digital camera 16, etc., wherein the processing speed and the supplied power amount are limited, and has only an image data acquisition section 500 and a communication IF 530. That is, the modification is a preferred mode to lessen processing as much as possible in the printer driver 56.

The image formation program 66 in the modification adopts a configuration wherein the image decompression section 622 in the image generation section 620 is eliminated from the components shown in FIG. 3 and a filtering section 626 is added.

In an image formation system 2 in the modification, image data is transmitted and received in a non-compression state through a network, but is transmitted and received in a compression state as code data on the printer path of the printer 20.

Thus, the image formation system 2 in the modification is preferred if the processing speed and the power amount of the image data transmission terminal are limited and the processing in the image data transmission terminal is to be suppressed as much as possible or if the printer 20 receives image data in a vector format and converts the image data into a raster image.

FIG. 14 is a diagram to describe the functional configuration of a printer driver 57 and an image formation program 67 for an image data transmission terminal to perform filtering and transmit image data to a printer 20. Components substantially identical with those previously described with reference to FIG. 3 are denoted by the same reference numerals in FIG. 14.

The printer driver 57 in the modification has an image data acquisition section 500, a filtering section 510, and a communication IF 530, and transmits the image data subjected to filtering to the image formation program 67 without coding.

Upon reception of uncompressed image data, an image generation section 620 of the image formation program 67 in the modification performs predetermined edit processing for the image data and reversibly codes the image data into code data.

Although an image data transmission terminal, such as a digital camera 16, does not have sufficient processing speed or a sufficient power amount, if image quality degradation caused by filtering is to be checked at the image data transmission terminal, the modification is preferred. That is, the user can execute filtering in the printer driver 57 and display change in the image quality caused by the filtering on the image data transmission terminal for check before transferring the image data to the printer 20 and requesting the printer 20 to print.

FIG. 15 is a diagram to describe the functional configuration of a printer driver 58 and an image formation program 68 for an image processing section 640 to again perform filtering. Components substantially identical with those previously described with reference to FIG. 3 are denoted by the same reference numerals in FIG. 15.

The image formation program 68 in the modification has a filtering section 626 in the image processing section 640 in addition to the components previously described with reference to FIG. 3. The filtering section 626 in the modification performs filtering for the image data which has been subjected to correction processing by the image processing section 640. Therefore, in the modification, filtering is performed just before print, it becomes particularly easy to control the image quality. If a new pixel value is generated as edit processing of an image generation section 620 or correction processing of the image processing section 640 (linear interpolation scale-up, etc.,) is performed, a sufficient compression ratio can be provided.

As described above, the image processing system according to the embodiment can repeat compression and decompression of image data without accumulating image quality degradation.

1. An image processing system comprising:
an image data transmission terminal;
an image formation apparatus;
a filtering section for performing filtering for image data;
a coding section for performing reversible coding processing for the image data subjected to the filtering by the filtering section; and
a decompression section for performing decompression processing for the image data subjected to the coding processing by the coding section, wherein
the filtering of the filtering section changes the pixel value of image data so as to be fitted for the coding processing of the coding section.

2. An image processing system comprising:
an image data transmission terminal; and
an image formation apparatus, wherein
the image data transmission terminal includes:
a filtering section for performing filtering for image data;
a coding section for performing reversible coding processing for the image data subjected to the filtering by the filtering section; and
a transmission section for transmitting the image data subjected to the coding processing by the coding section to the image formation apparatus, and wherein
the image formation apparatus includes:
a reception section for receiving the image data from the image data transmission terminal; and
a decompression section for performing decompression processing for the image data received by the reception section, and wherein
the filtering of the filtering section changes the pixel value of image data so as to be fitted for the coding processing of the coding section.

3. An image processing system comprising:
an image data transmission terminal; and
an image formation apparatus, wherein
the image data transmission terminal includes:
a filtering section for performing filtering for image data; and
a transmission section for transmitting the image data subjected to the filtering by the filtering section to the image formation apparatus, and wherein
the image formation apparatus includes:
a reception section for receiving the image data from the image data transmission terminal;
a coding section for performing reversible coding processing for the image data received by the reception section; and
a decompression section for performing decompression processing for the image data subjected to the coding processing by the coding section, and wherein
the filtering of the filtering section changes the pixel value of image data so as to be fitted for the coding processing of the coding section.

4. The image processing system according to claim 1, wherein
the filtering section performs filtering corresponding to an algorithm of the coding processing of the coding section.

5. The image processing system according to claim 4, further comprising:
an edit section for performing edit processing for the image data decompressed by the decompression section;
a re-coding section for performing coding processing for the image data subjected to the edit processing;
a re-decompression section for performing decompression processing for the image data subjected to the coding processing by the re-coding section; and
an image formation section for forming an image based on the image data decompressed by the re-decompression section.

6. The image processing system according to claim 1, wherein
to perform coding processing for an attention pixel unit in the image data, the coding section references the pixel value of a pixel unit at a preset position and performs coding processing.

7. The image processing system according to claim 6, wherein
as the filtering, the filtering section changes the pixel value of the attention pixel unit so as to raise the probability that the pixel value of the attention pixel unit will match the pixel value of the pixel unit at the preset position.

8. The image processing system according to claim 1, wherein
the filtering section changes the pixel value of the attention pixel unit in response to the spatial frequency of the image data.

9. The image processing system according to claim 1, wherein
as the filtering, the filtering section changes the pixel value of the attention pixel unit in the image data so as to decrease the code amount of coding of the coding section and distributes the change amount produced by changing the pixel value to peripheral pixels, and wherein
the coding section codes the pixel value changed by the filtering.

10. The image processing system according to claim 1, further comprising:
a parameter generation section for generating a filter parameter in response to a specified compression ratio, wherein
the filtering section performs the filtering in response to the generated filter parameter.

11. The image processing system according tto claim 10, wherein
the parameter generation section generates the filter parameter in response to the speed at which data can be transferred to the image formation apparatus or the operation state of the image formation apparatus.

12. The image processing system according to claim 2, wherein
the image formation apparatus further includes a re-filtering section for performing the filtering for the image data subjected to the edit processing by the edit section in response to the type of edit processing or the operation state of the image formation apparatus.

13. An image formation apparatus comprising:
a reception section for receiving image data subjected to filtering;
a coding section for performing reversible coding processing for the image data received by the reception section;
a decompression section for performing decompression processing for the image data subjected to the coding processing by the coding section;
an edit section for performing edit processing for the decompressed image data;
a re-coding section for performing reversible coding processing for the image data subjected to the edit processing;
a re-decompression section for performing decompression processing for the image data subjected to the coding processing by the re-coding section; and
an image formation section for forming an image based on the image data decompressed by the re-decompression section.

14. An image formation apparatus comprising:
a reception section for receiving image data subjected to filtering and reversible coding processing;
a decompression section for performing decompression processing for the image data received by the reception section;
an edit section for performing edit processing for the decompressed image data;
a re-coding section for performing reversible coding processing for the image data subjected to the edit processing;
a re-decompression section for performing decompression processing for the image data subjected to the coding processing by the re-coding section; and
an image formation section for forming an image based on the image data decompressed by the re-decompression section.

15. An image formation apparatus comprising:
an filtering section for performing filtering for image data;
a coding section for performing reversible coding processing for the image data subjected to the filtering by the filtering section;
a decompression section for performing decompression processing for the image data subjected to the coding processing by the coding section;
an edit section for performing edit processing for the decompressed image data;
a re-coding section for performing reversible coding processing for the image data subjected to the edit processing;
a re-decompression section for performing decompression processing for the image data subjected to the coding processing by the re-coding section; and
an image formation section for forming an image based on the image data decompressed by the re-decompression section.

16. An image processing method for repeating coding processing and decompression processing of image data, the method comprising:
performing filtering of changing the pixel value so as to fit for reversible coding processing for image data;
performing reversible coding processing for the image data subjected to the filtering; and
performing decompression processing for the image data subjected to the coding processing.

17. A program executable by a computer for an image processing system including an image data transmission terminal having the computer, and an image formation apparatus, the program comprising:
performing filtering of changing the pixel value so as to fit for reversible coding processing for image data; and
transmitting the image data subjected to the filtering to the image formation apparatus.

18. A program executable by a computer for an image processing system including an image data transmission terminal having the computer, and an image formation apparatus, the program comprising:
performing filtering of changing the pixel value so as to fit for reversible coding processing for image data;
performing reversible coding processing for the image data subjected to the filtering; and
transmitting the image data subjected to the coding processing to the image formation apparatus.
